(19) United States
(12) Patent Application Publication
(10) Pub. No.: US 2013/0057064 A1
(43) Pub. Date: Mar. 7, 2013

(54) POWER SUPPLY SYSTEM FOR AIR CONDITIONER OF CAR

(71) Applicants: JIN-LIANG XIONG, Shenzhen City (CN); YI-XIN TU, Shenzhen City (CN); HAI-QING ZHOU, Shenzhen City (CN)

(72) Inventors: JIN-LIANG XIONG, Shenzhen City (CN); YI-XIN TU, Shenzhen City (CN); HAI-QING ZHOU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/305,106

(22) Filed: Nov. 28, 2011

(30) Foreign Application Priority Data
Sep. 6, 2011 (CN) 201110262111.6

(51) Int. Cl. B60L 1/00

(52) U.S. Cl. 307/10.1

(57) ABSTRACT

A power supply system for an air conditioner of a car includes a battery, an alternator, a detection circuit to detect whether the alternator is operating and outputting a detection signal according to the detection result, a processing unit to output a control signal according to the detection signal, and a switching circuit to connect either the battery or the alternator to the air conditioner.

### BACKGROUND

1. Technical Field

The present disclosure relates to a power supply system for an air conditioner of a car.

2. Description of Related Art

When a car is started, an alternator of the car may supply power to an air conditioner. When the car engine stops, a battery may supply power through a relay to the air conditioner. However, because the contacts of the relay operate mechanically, after a number of open and close cycles, the relay may operate unreliably.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a block diagram of an exemplary embodiment of a power supply system for an air conditioner of a car.

FIG. 2 is a schematic diagram of the power supply system of FIG. 1.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

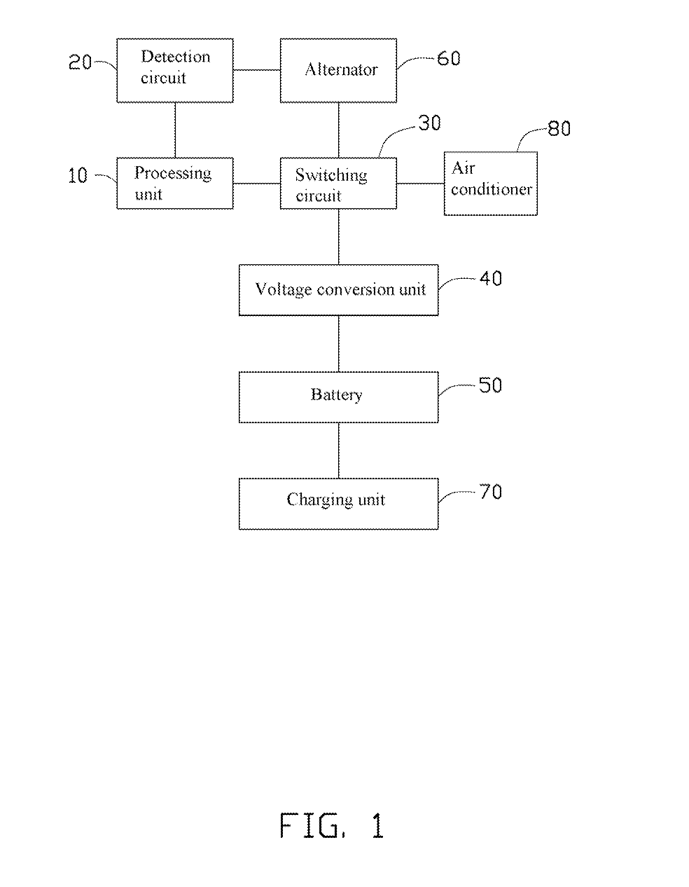

Referring to FIG. 1, an exemplary embodiment of a power supply system for an air conditioner 80 of a car includes a processing unit 10, a detection circuit 20, a switching circuit 30, a voltage conversion unit 40, a battery 50, an alternator 60, and a charging unit 70.

In the embodiment, the charging unit 70 includes a solar panel and a charging circuit. The solar panel can be mounted on a top of the car to receive the solar energy, to keep the battery 50 charged.

The voltage conversion unit 40 converts the voltage from the battery 50 to a voltage fit for the air conditioner 80, and outputs the converted voltage to the switching circuit 30.

The detection circuit 20 detects the operation of the alternator 60, and outputs a detection signal to the processing unit 10. The alternator 60 may function and supply power for the air conditioner 80 when the car engine is started.

The processing unit 10 outputs a control signal to the switching circuit 30 according to the detection signal from the detection circuit 20.

The switching circuit 30 allows either the alternator 60 or the battery 50 to supply power for the air conditioner 80, according to the control signal from the processing unit 10.

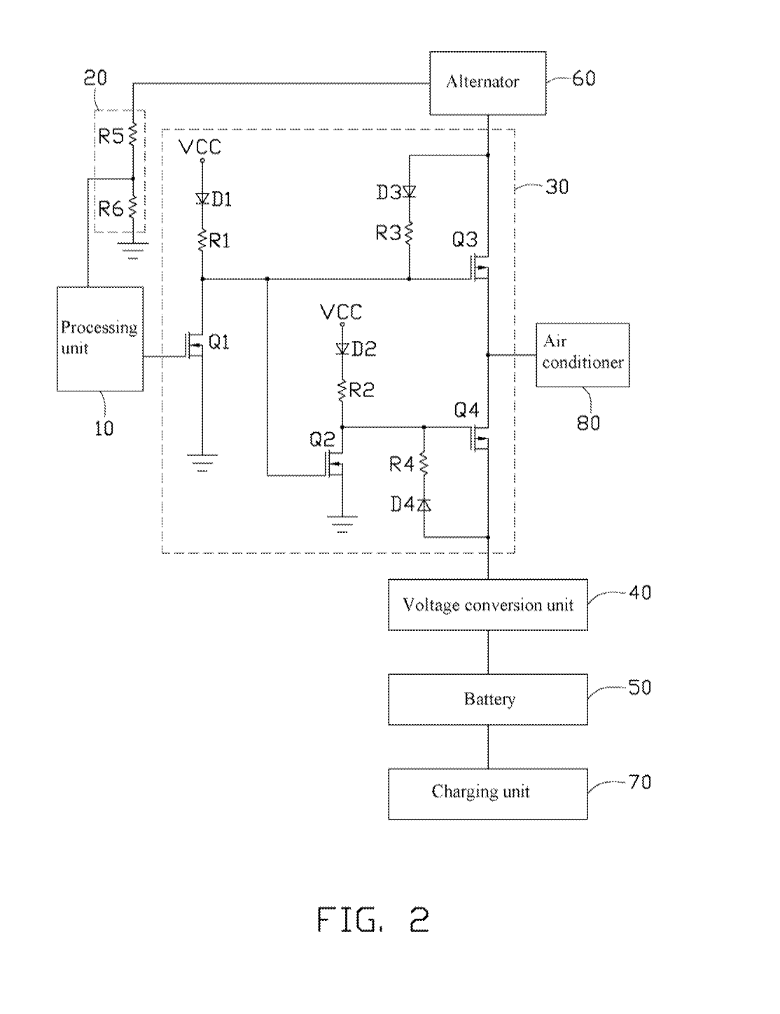

Referring to FIG. 2, the switching circuit 30 includes first to fourth field effect transistors (FETs) Q1, Q2, Q3, and Q4, first to fourth resistors R1, R2, R3, and R4, and four diodes D1, D2, D3, and D4. In the embodiment, the FETs Q1 and Q2 are n-channel FETs, and the FETs Q3 and Q4 are p-channel FETs.

A gate of the first FET Q1 is connected to the processing unit 10 to receive the control signal. A source of the first FET Q1 is grounded. A drain of the first FET Q1 is connected to a cathode of the diode D1 through the first resistor R1. An anode of the diode D1 is connected to a power supply VCC. The drain of the first FET Q1 is further connected to gates of the second FET Q2 and the third FET Q3. A source of the second FET Q2 is grounded. A drain of the second FET Q2 is connected to a cathode of the diode D2 through the second resistor R2. An anode of the diode D2 is connected to the power supply VCC.

The drain of the second FET Q2 is further connected to a gate of the fourth FET Q4. A source of the fourth FET Q4 is connected to the voltage conversion unit 40. The gate of the fourth FET Q4 is further connected to a cathode of the diode D4 through the fourth resistor R4. An anode of the diode D4 is connected to the source of the fourth FET Q4. A drain of the third FET Q3 is connected to the alternator 60. The gate of the third FET Q3 is further connected to a cathode of the diode D3 through the third resistor R3. An anode of the diode D3 is connected to the drain of the third FET Q3. A source of the third FET Q3 is connected to the drain of the fourth FET Q4 and to the air conditioner 80.

The detection circuit 20 includes a fifth resistor R5 and a sixth resistor R6. The alternator 60 is grounded through the fifth resistor R5 and the sixth resistor R6, in that order. A node between the fifth resistor R5 and the sixth resistor R6 is connected to the processing unit 10.

When the alternator 60 is operating, namely after the car engine has started, a voltage at the node between the fifth resistor R5 and the sixth resistor R6 is at a high level, such as logic 1. The processing unit 10 accordingly outputs a control signal at a high level to the switching circuit 30. The first FET Q1 is turned on and the third FET Q3 is turned on. As a result, the alternator 60 can directly supply power to the air conditioner 80. At the same time, the second FET Q2 and the fourth FET Q4 are turned off so that the battery 50 is disconnected from the air conditioner 80.

When the car engine and thus the alternator 60 stop operating, the voltage at the node between the fifth resistor R5 and the sixth resistor R6 is at a low level, such as logic 0. The processing unit 10 outputs a control signal at a low level to the switching circuit 30 accordingly. The first FET Q1 is turned off and the third FET Q3 is turned off. As a result, the alternator 60 is disconnected from the air conditioner 80 but at the same time, the second FET Q2 and the fourth FET Q4 are turned on, thus the battery 50 can supply power to the air conditioner 80.

The FETs Q1-Q4 function as simple electronic switches in this embodiment. Therefore, the FETs Q1 -Q4 can be replaced by other electronic or transistor switches as appropriate. The diodes D1-D3 are used for protecting the FETs Q1-Q3. The diode D4 is used for avoiding the current flowed from the battery 50 to the gate of the FET Q4 when the alternator 60 is at work.

The foregoing description of the exemplary embodiments of the disclosure has been presented only for the purposes of illustration and description and is not intended to be exhaustive or to limit the disclosure to the precise forms disclosed. Many modifications and variations are possible in the light of everything above. The embodiments were chosen and described in order to explain the principles of the disclosure and their practical application so as to enable others of ordinary skill in the art to utilize the disclosure and various embodiments, with such modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A power supply system for an air conditioner of a car, the power supply system comprising:
a battery;
an alternator;
a detection circuit to detect whether the alternator operates and output a detection signal according to the detection result;
a processing unit to output a control signal according to the detection signal; and
a switching circuit connecting the battery or the alternator to the air conditioner, wherein the switching circuit comprises first to fourth electronic switches, first to fourth resistors, and a first diode, each electronic switch comprises a control terminal, a first terminal, and a second terminal, the control terminal of the first electronic switch is connected to the processing unit for receiving the control signal, the first terminal of the first electronic switch is grounded, the second terminal of the first electronic switch is connected to a power supply through the first resistor, the second terminal of the first electronic switch is further connected to control terminals of the second and third electronic switches, the first terminal of the second electronic switch is grounded, the second terminal of the second electronic switch is connected to the power supply through the second resistor, the second terminal of the second electronic switch is further connected to the control terminal of the fourth electronic switch, the first terminal of the fourth electronic switch is connected to the battery, the control terminal of the fourth electronic switch is connected to a cathode of the first diode through the fourth resistor, an anode of the first diode is connected to the first terminal of the fourth electronic switch, the second terminal of the third electronic switch is connected to the alternator, the control terminal of the third electronic switch is connected to the second terminal of the third electronic switch through the third resistor, the first terminal of the third electronic switch is connected to the second terminal of the fourth electronic switch and the air conditioner;
wherein the first and second electronic switches are turned on in response to the corresponding control terminals receiving high level voltage signals, the third and fourth electronic switches are turned on in response to the corresponding control terminals receiving low level voltage signals.

2. The power supply system of claim 1, further comprising a voltage conversion unit, wherein the battery is connected to the first terminal of the fourth electronic switch through the voltage conversion unit, the voltage conversion unit converts a first voltage from the battery to a second voltage fit for the air conditioner.

3. The power supply system of claim 1, wherein the detection circuit comprises a fifth resistor and a sixth resistor, the alternator is grounded through the fifth resistor and the sixth resistor connected in series, a node between the fifth resistor and the sixth resistor is connected to the processing unit.

4. The power supply system of claim 1, further comprising a charging unit to charge the battery.

5. The power supply system of claim 1, wherein the switching circuit further comprises second to fourth diodes, an anode of the second diode is connected to the power supply, a cathode of the second diode is connected to the first resistor, an anode of the third diode is connected to the power supply, a cathode of the third diode is connected to the second resistor, an anode of the fourth diode is connected to the second terminal of the third electronic switch, a cathode of the fourth diode is connected to the third resistor.

6. The power supply system of claim 1, wherein the first and second electronic switches are n-channel field effect transistors, and the third and fourth electronic switches are p-channel field effect transistors, the control terminals, the first terminals, and the second terminals are gates, sources, and drains of the field effect transistors.
